(19) United States
(12) Patent Application Publication
(10) Pub. No.: US 2024/0103844 A1
(43) Pub. Date: Mar. 28, 2024

(54) SYSTEMS AND METHODS FOR SELECTIVE REBOOTLESS FIRMWARE UPDATES

(71) Applicant: Dell Products, L.P., Round Rock, TX (US)

(72) Inventors: Chandrasekhar R, Bangalore (IN); Rochak Gupta, Bangalore (IN); Rama Rao Bisa, Bangalore (IN); Deepaganesh Paulraj, Bangalrore (IN); Sandesh Hadhimane Balakrishna, Bangalore (IN)

(73) Assignee: Dell Products, L.P., Round Rock, TX (US)

(21) Appl. No.: 17/934,669

(22) Filed: Sep. 23, 2022

(51) Int. Cl. G06F 8/656

(52) U.S. Cl. CPC G06F 8/656

(57) ABSTRACT

Embodiments of systems and methods to provide a firmware update to devices configured in a redundant configuration in an Information Handling System (IHS) are disclosed. In an illustrative, non-limiting embodiment, an IHS may include first and second Remote Access Controllers (RACs) that each includes computer-executable instructions to receive a firmware update image associated with the firmware device, and gather data associated with a behavior of the firmware device following the firmware update after the firmware device is updated with the firmware update image. Using the data, the instructions generate a score for the firmware update based at least in part, on the behavior of the IHS following the firmware update.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Various hardware components of an IHS may operate using firmware instructions. From time to time, it is expected that firmware utilized by hardware components of an IHS may be updated. Such firmware updates may be made in order to modify the capabilities of a particular hardware component, such as to address security vulnerabilities or to adapt the operations of the hardware component to a specific computing task. When firmware updates are made to a hardware component of an IHS, it is preferable that the IHS experience no downtime and with minimal degradation in the performance of the IHS.

Nowadays, software updates are typically made available on one or more download sites as soon as the software provider can produce them. In this manner, software providers can be more responsive to critical flaws, security concerns, and general customer needs. To update software, a customer would query an update site for software updates, and download and install the software update if available. For example, a typical network-based software update procedure may include the steps of issuing a request over a network to a software provider's download site (e.g., update source) for a software update applicable to the client computer. The update source responds to the client computer with the software update requested by the client computer in the update request. After the client computer has received the software update, the client computer installs the received software update.

One benefit of updating software in such a manner is the reduced cost associated with producing and distributing software updates. Additionally, software updates can now be performed more frequently, especially those that address critical issues and security. Still further, a computer user has greater control as to when and which software updates should be installed on the client computer.

### SUMMARY

Embodiments of systems and methods to provide a firmware update to devices configured in a redundant configuration in an Information Handling System (IHS) are disclosed. In an illustrative, non-limiting embodiment, an IHS may include first and second Remote Access Controllers (RACs) that each includes computer-executable instructions to receive a firmware update image associated with the firmware device, and gather data associated with a behavior of the firmware device following the firmware update after the firmware device is updated with the firmware update image. Using the data, the instructions generate a score for the firmware update based at least in part, on the behavior of the IHS following the firmware update.

According to another embodiment, a selective rebootless firmware update method includes the steps of receiving a firmware update image associated with a firmware device, after the firmware device is updated with the firmware update image, gathering data associated with a behavior of the firmware device following the firmware update, and generating a score for the firmware update based at least in part, on the behavior of the IHS following the firmware update.

According to yet another embodiment, a memory storage device is configured with program instructions that, upon execution by an Information Handling System (IHS), cause the IHS to receive a firmware update image associated with a firmware device; after the firmware device is updated with the firmware update image, gather data associated with a behavior of the firmware device following the firmware update, and generate a score for the firmware update based at least in part, on the behavior of the IHS following the firmware update.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A and 1B are block diagrams illustrating certain components of a chassis comprising one or more compute sleds and one or more storage sleds that may be configured to implement the systems and methods described according to one embodiment of the present disclosure.

FIG. 2 illustrates an example of an IHS configured to implement systems and methods described herein according to one embodiment of the present disclosure.

FIG. 3 is a diagram view illustrating several components of an example selective rebootless firmware update system according to one embodiment of the present disclosure.

FIG. 4 illustrates an example recommendations window that may be generated by the system to provide the user with recommendations for performing a firmware update according to one embodiment of the present disclosure.

FIG. 5 is a flow diagram illustrating an example selective rebootless firmware update method depicting how a firmware device configured in an IHS may be updated according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Firmware updates of server components is an important aspect of the life cycle management of an Information Handling System (IHS), (e.g., server, host, etc.). Traditional means of updating IHS firmware devices have involved migrating the workloads running on the host Operating System (OS), a reboot job is created, the IHS is rebooted, and firmware update is performed. Additionally, the IHS is again rebooted to activate the new firmware on the IHS components. This process, however, may not be customer friendly as the IHS is often required to be down for the firmware update process, thus impacting business. Because IHSs are forced to reboot to perform the firmware updates, customers often wait for its maintenance cycle to update the IHS components, thus missing the new firmware features, security fixes, performance improvements, and the like. As such, rebootless updates may be an important aspect of efficient computer operations. Using rebootless updates, users may be enabled with performing the updates without rebooting the servers and get more useful features above what today's industry specifications can provide.

Customers often upgrade the firmware in the IHSs of a data center for assorted reasons, such as to meet compliance policies, to take advantage of new features, enhancements to the IHS, deploy security fixes, and the like. IHSs that are NVMe-MI/PLDM Specification compliant can take advantage of updating firmware to all IHSs in a system or in a cluster without rebooting the IHSs. Devices that support Platform Level Data Model (PLDM) offers an option for a Remote Access Controller (RAC) to update the firmware without rebooting the IHS. Thus, downtime is often not incurred during the firmware update process. The RAC may be configured to provide out-of-band management facilities for an IHS, even if it is powered off, or powered down to a standby state. The RAC may include a processor, memory, and an out-of-band network interface separate from and physically isolated from an in-band network interface of the IHS, and/or other embedded resources. In certain embodiments, the RAC may include or may be part of a Remote Access Controller (e.g., a DELL Remote Access Controller (DRAC) or an Integrated DRAC (iDRAC)).

The RAC may support rebootless firmware updates for firmware devices, such as non-volatile storage (e.g., hard disks, Solid State Drives (SSDs), etc.), Network Interface Cards (NICs), Graphical Processing Units (GPUs), RACs, Hardware RAID (HWRAID) devices, and the like. With the reboot less feature, when a firmware update image is uploaded using a RAC user interface, all the firmware devices supported by the firmware update image may be automatically selected and updated using rebootless update methods in the real-time without rebooting the IHS.

A RAC may implement a Platform Management Components Intercommunication (PMCI) interface stack that is provided by the Distributed Management Task Force (DMTF), and specifies a Management Component Transport Protocol (MCTP) specifying how data travels over certain physical layers, such as the peripheral component interconnect express (PCIe) and I2C/SMBus. Additionally, the PMCI interface stack may further include the Platform Level Data Model (PLDM) protocol that enables information to travel over the MCTP transport layer and can be used for platform management, such as firmware updates.

If a firmware update or firmware update image transfer fails due to any reason (e.g., faulty firmware update image, device incompatibility, etc.), then the IHS may exhibit what could otherwise be used to prevent similar operations in the future, but heretofore no viable solutions have been implemented to solve such problems. Sometimes, the firmware update may be successful, but after the new firmware is activated, it may result in issues or problems. For example, a new firmware update, which has been developed to use a new communication technology (e.g., PCIe VDM channel), may be implemented on a particular firmware device. But if other firmware devices in the IHS are not yet configured to inter-operate with the firmware device using the new communication channel, certain problems may occur. As another example, a new firmware update may be configured to cause its respective firmware device to concurrently communicate with other firmware devices using multiple communication channels (e.g., I2C and PCI3 VDM), but if other firmware devices in the IHS do not adequately handle the use of multiple communication channels, problems may be caused by the new firmware update. By learning from such experiences and avoiding the same firmware update on the other IHSs may avoid downtime and result in a better customer experience. As will be described in detail herein below, embodiments of the present disclosure provide a solution to this problem, among other problems, via a selective rebootless firmware update system that measures a behavior of the firmware device following a firmware update using a firmware update image, and generates a score for the firmware update based at least in part, on the measured behavior of the IHS. Later on, when a user attempts to perform an ensuing firmware update using that firmware update image, the system displays the score so that the user may be able to select whether or not to continue with the firmware update.

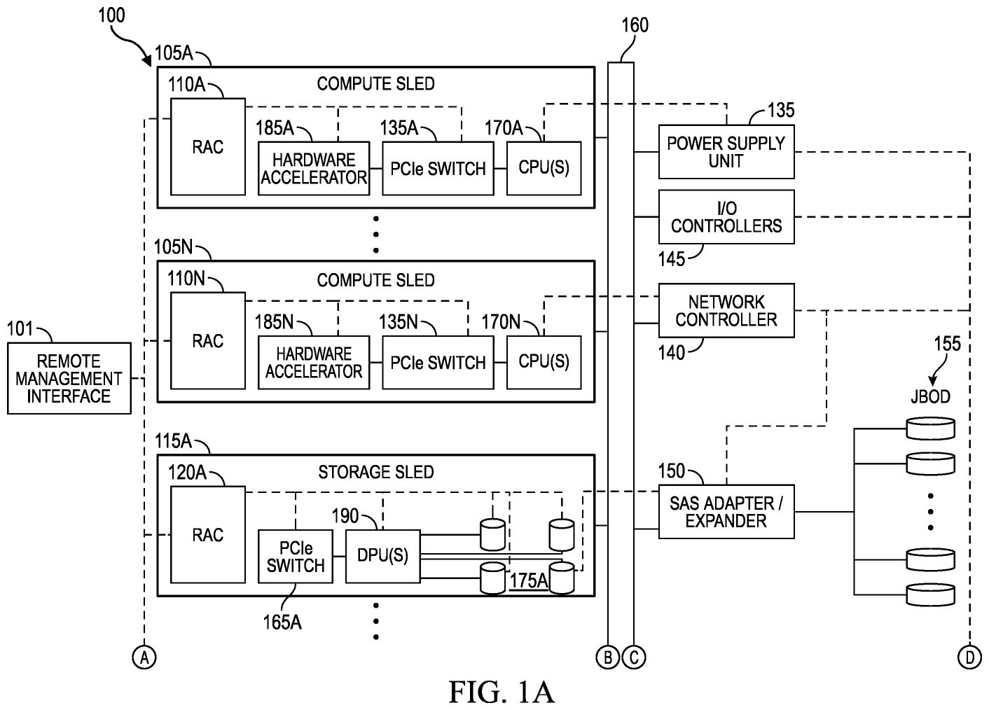

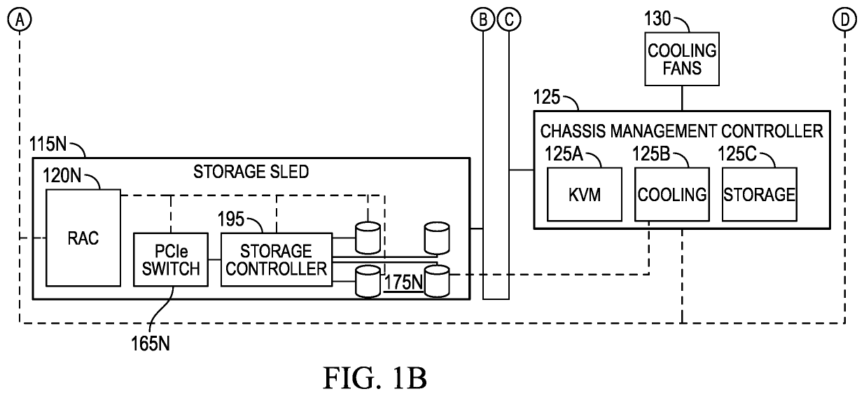

FIGS. 1A and 1B are block diagrams illustrating certain components of a chassis 100 comprising one or more compute sleds 105a-n and one or more storage sleds 115a-n that may be configured to implement the systems and methods described according to one embodiment of the present disclosure. Embodiments of chassis 100 may include a wide variety of hardware configurations in which one or more sleds 105a-n, 115a-n are installed in chassis 100. Such variations in hardware configuration may result from chassis 100 being factory assembled to include components specified by a customer that has contracted for manufacture and delivery of chassis 100. Upon delivery and deployment of a chassis 100, the chassis 100 may be modified by replacing and/or adding various hardware components, in addition to replacement of the removable sleds 105a-n, 115a-n that are installed in the chassis. In addition, once the chassis 100 has been deployed, firmware used by individual hardware components of the sleds 105a-n, 115a-n, or by other hardware components of chassis 100, may be modified in order to update the operations that are supported by these hardware components.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Embodiments may include additional types of sleds that provide various storage, power and/or processing capabilities. For instance, sleds installable in chassis 100 may be dedicated to providing power management or networking functions. Sleds may be individually installed and removed from the chassis 100, thus allowing the computing and storage capabilities of a chassis to be reconfigured by swapping the sleds with diverse types of sleds, in some cases at runtime without disrupting the ongoing operations of the other sleds installed in the chassis 100.

Multiple chassis 100 may be housed within a rack. Data centers may utilize large numbers of racks, with various different types of chassis installed in various configurations of racks. The modular architecture provided by the sleds, chassis and racks allow for certain resources, such as cooling, power and network bandwidth, to be shared by the compute sleds 105a-n and storage sleds 115a-n, thus providing efficiency improvements and supporting greater computational loads. For instance, certain computational tasks, such as computations used in machine learning and other artificial intelligence systems, may utilize computational and/or storage resources that are shared within an IHS, within an individual chassis 100 and/or within a set of IHSs that may be spread across multiple chassis of a data center.

Implementing computing systems that span multiple processing components of chassis 100 is aided by high-speed data links between these processing components, such as PCIe connections that form one or more distinct PCIe switch fabrics that are implemented by PCIe switches 135a-n, 165a-n installed in the sleds 105a-n, 115a-n of the chassis. These high-speed data links may be used to support algorithm implementations that span multiple processing, networking, and storage components of an IHS and/or chassis 100. For instance, computational tasks may be delegated to a specific processing component of an IHS, such as to a hardware accelerator 185a-n that may include one or more programmable processors that operate separate from the main CPUs 170a-n of computing sleds 105a-n. In various embodiments, such hardware accelerators 185a-n may include DPUs (Data Processing Units), GPUs (Graphics Processing Units), SmartNlCs (Smart Network Interface Card) and/or FPGAs (Field Programmable Gate Arrays). These hardware accelerators 185a-n operate according to firmware instructions that may be occasionally updated, such as to adapt the capabilities of the respective hardware accelerators 185a-n to specific computing tasks.

Chassis 100 may be installed within a rack structure that provides at least a portion of the cooling utilized by the sleds 105a-n, 115a-n installed in chassis 100. In supporting airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air away from sleds 105a-n, 115a-n installed within the chassis. In this manner, a rack and a chassis 100 installed within the rack may utilize various configurations and combinations of cooling fans 130 to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160 and between different components mounted on the printed circuit board of the backplane 160. In the illustrated embodiment, the connectors for use in coupling sleds 105a-n, 115a-n to backplane 160 include PCIe couplings that support high-speed data links with the sleds 105a-n, 115a-n. In various embodiments, backplane 160 may support diverse types of connections, such as cables, wires, midplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140, chassis management controller 125 and power supply unit 135.

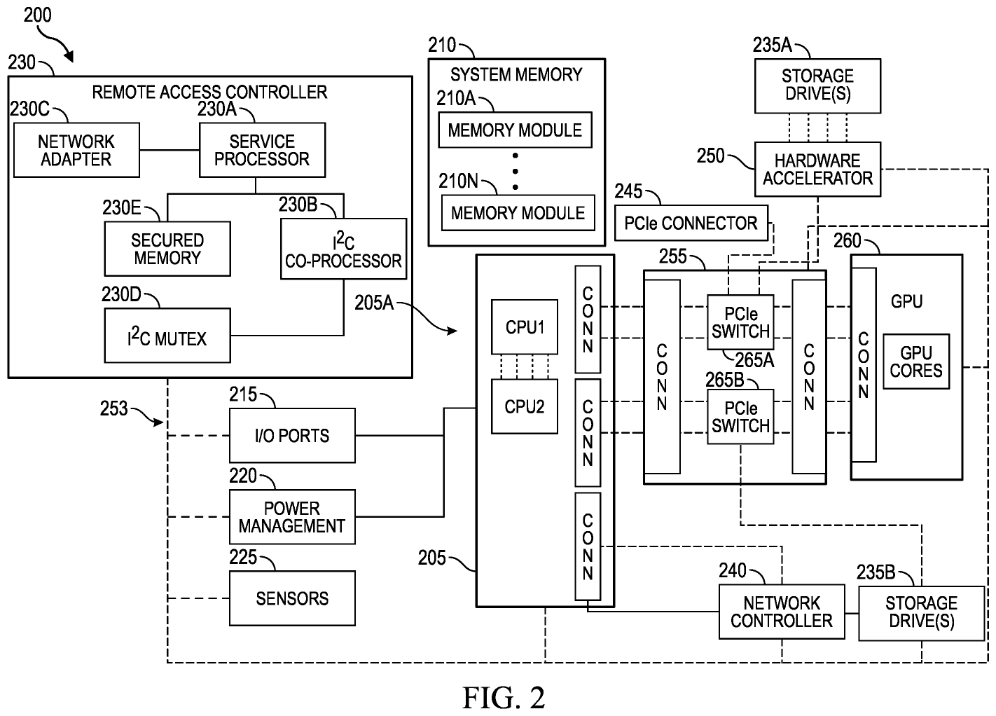

In certain embodiments, each individual sled 105a-n, 115a-n may be an IHS such as described with regard to IHS 200 of FIG. 2. Sleds 105a-n, 115a-n may individually or collectively provide computational processing resources that may be used to support a variety of e-commerce, multimedia, business, and scientific computing applications, such as artificial intelligence systems provided via cloud computing implementations. Sleds 105a-n, 115a-n are typically configured with hardware and software that provide leading-edge computational capabilities. Accordingly, services that are provided using such computing capabilities are typically provided as high-availability systems that operate with minimum downtime.

In high-availability computing systems, such as may be implemented using embodiments of chassis 100, any downtime that can be avoided is preferred. As described above, firmware updates are expected in the administration and operation of data centers, but it is preferable to avoid any downtime in making such firmware updates. For instance, in updating the firmware of the individual hardware components of the chassis 100, it is preferable that such updates can be made without having to reboot the chassis. As described in additional detail below, it is also preferable that updates to the firmware of individual hardware components of sleds 105a-n, 115a-n be likewise made without having to reboot the respective sled of the hardware component that is being updated.

As illustrated, each sled 105a-n, 115a-n includes a respective remote access controller (RAC) 110a-n, 120a-n. As described in additional detail with regard to FIG. 2, remote access controller 110a-n, 120a-n provides capabilities for remote monitoring and management of a respective sled 105a-n, 115a-n and/or of chassis 100. In support of these monitoring and management functions, remote access controllers 110a-n may utilize both in-band and side-band (i.e., out-of-band) communications with various managed components of a respective sled 105a-n and chassis 100. Remote access controllers 110a-n, 120a-n may collect diverse types of sensor data, such as collecting temperature sensor readings that are used in support of airflow cooling of the chassis 100 and the sled 105a-n, 115a-n. In addition, each remote access controller 110a-n, 120a-n may implement various monitoring and administrative functions related to a respective sled 105a-n, 115a-n, where these functions may be implemented using sideband bus connections with various internal components of the chassis 100 and of the respective sleds 105a-n, 115a-n. As described in additional detail below, in various embodiments, these capabilities of the remote access controllers 110a-n, 120a-n may be utilized in updating the firmware of hardware components of chassis 100 and/or of hardware components of the sleds 105a-n, 115a-n, without having to reboot the chassis or any of the sleds 105a-n, 115a-n.

The remote access controllers 110a-n, 120a-n that are present in chassis 100 may support secure connections with a remote management interface 101. In some embodiments, remote management interface 101 provides a remote administrator with various capabilities for remotely administering the operation of an IHS, including initiating updates to the firmware used by hardware components installed in the chassis 100. For example, remote management interface 101 may provide capabilities by which an administrator can initiate updates to all of the storage drives 175a-n installed in a chassis 100, or to all of the storage drives 175a-n of a particular model or manufacturer. In some instances, remote management interface 101 may include an inventory of the hardware, software, and firmware of chassis 100 that is being remotely managed through the operation of the remote access controllers 110a-n, 120a-n. The remote management interface 101 may also include various monitoring interfaces for evaluating telemetry data collected by the remote access controllers 110a-n, 120a-n. In some embodiments, remote management interface 101 may communicate with remote access controllers 110a-n, 120a-n via a protocol such the Redfish remote management interface.

In the illustrated embodiment, chassis 100 includes one or more compute sleds 105a-n that are coupled to the backplane 160 and installed within one or more bays or slots of chassis 100. Each of the individual compute sleds 105a-n may be an IHS, such as described with regard to FIG. 2. Each of the individual compute sleds 105a-n may include various different numbers and types of processors that may be adapted to performing specific computing tasks. In the illustrated embodiment, each of the compute sleds 105a-n includes a PCIe switch 135a-n that provides access to a hardware accelerator 185a-n, such as the described DPUs, GPUs, Smart NICs and FPGAs, which may be programmed and adapted for specific computing tasks, such as to support machine learning or other artificial intelligence systems. As described in additional detail below, compute sleds 105a-n may include a variety of hardware components, such as hardware accelerator 185a-n and PCIe switches 135a-n, that operate using firmware that may be occasionally updated.

As illustrated, chassis 100 includes one or more storage sleds 115a-n that are coupled to the backplane 160 and installed within one or more bays of chassis 100 in a similar manner to compute sleds 105a-n. Each of the individual storage sleds 115a-n may include various different numbers and types of storage devices. As described in additional detail with regard to FIG. 2, a storage sled 115a-n may be an IHS 200 that includes multiple solid-state drives (SSDs) 175a-n, where the individual storage drives 175a-n may be accessed through a PCIe switch 165a-n of the respective storage sled 115a-n.

As illustrated, a storage sled 115a may include one or more DPUs (Data Processing Units) 190 that provide access to and manage the operations of the storage drives 175a of the storage sled 115a. Use of a DPU 190 in this manner provides low-latency and high-bandwidth access to numerous SSDs 175a. These SSDs 175a may be utilized in parallel through NVMe transmissions that are supported by the PCIe switch 165a that connects the SSDs 175a to the DPU 190. In some instances, PCIe switch 165a may be an integrated component of a DPU 190. The immense data storage and retrieval capabilities provided by such storage sled 115a implementations may be harnessed by offloading storage operations directed as storage drives 175a to a DPU 190a, and thus without relying on the main CPU of the storage sled, or of any other component of chassis 100. As indicated in FIG. 1, chassis 100 may also include one or more storage sleds 115n that provide access to storage drives 175n via a storage controller 195. In some embodiments, storage controller 195 may provide support for RAID (Redundant Array of Independent Disks) configurations of logical and physical storage drives, such as storage drives provided by storage sled 115n. In some embodiments, storage controller 195 may be a HBA (Host Bus Adapter) that provides more limited capabilities in accessing storage drives 175n.

In addition to the data storage capabilities provided by storage sleds 115a-n, chassis 100 may provide access to other storage resources that may be installed components of chassis 100 and/or may be installed elsewhere within a rack that houses the chassis 100. In certain scenarios, such storage resources (e.g., JBOD 155) may be accessed via a SAS expander 150 that is coupled to the backplane 160 of the chassis 100. The SAS expander 150 may support connections to a number of JBOD (Just a Bunch of Disks) storage resources 155 that, in some instances, may be configured and managed individually and without implementing data redundancy across the various drives. The additional JBOD storage resources 155 may also be at various other locations within a datacenter in which chassis 100 is installed.

In light of the various manners in which storage drives 175a-n, 155 may be coupled to chassis 100, a wide variety of different storage topologies may be supported. Through these supported topologies, storage drives 175a-n, 155 may be logically organized into clusters or other groupings that may be collectively tasked and managed. In some instances, a chassis 100 may include numerous storage drives 175a-n, 155 that are identical, or nearly identical, such as arrays of SSDs of the same manufacturer and model. Accordingly, any firmware updates to storage drives 175a-n, 155 requires the updates to be applied within each of these topologies being supported by the chassis 100. Despite the large number of different storage drive topologies that may be supported by an individual chassis 100, the firmware used by each of these storage devices 175a-n, 155 may be occasionally updated. In some instances, firmware updates may be limited to a single storage drive, but in other instances, firmware updates may be initiated for a large number of storage drives, such as for all SSDs installed in chassis 100.

As illustrated, the chassis 100 of FIG. 1 includes a network controller 140 that provides network access to the sleds 105a-n, 115a-n installed within the chassis. Network controller 140 may include various switches, adapters, controllers, and couplings used to connect chassis 100 to a network, either directly or via additional networking components and connections provided via a rack in which chassis 100 is installed. Network controller 140 operates according to firmware instructions that may be occasionally updated.

Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units. Power supply unit 135 may operate according to firmware instructions that may be occasionally updated.

Chassis 100 may also include various I/O controllers 145 that may support various I/O ports, such as USB ports that may be used to support keyboard and mouse inputs and/or video display capabilities. Each of the I/O controllers 145 may operate according to firmware instructions that may be occasionally updated. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power supply unit 135, network controller 140 and airflow cooling fans 130 that are available via the chassis 100. As described, the airflow cooling fans 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 illustrates an example of an IHS 200 configured to implement systems and methods described herein according to one embodiment of the present disclosure. It should be appreciated that although the embodiments described herein may describe an IHS that is a compute sled or similar computing component that may be deployed within the bays of a chassis, a variety of other types of IHSs, such as laptops and portable devices, may also operate according to embodiments described herein. In the illustrative embodiment of FIG. 2, IHS 200 may be a computing component, such as sled 105a-n, 115a-n or other type of server, such as an 1 RU server installed within a 2RU chassis, which is configured to share infrastructure resources provided within a chassis 100.

IHS 200 may utilize one or more system processors 205, that may be referred to as CPUs (central processing units). In some embodiments, CPUs 205 may each include a plurality of processing cores that may be separately delegated with computing tasks. Each of the CPUs 205 may be individually designated as a main processor and as a co-processor, where such designations may be based on delegation of specific types of computational tasks to a CPU 205. In some embodiments, CPUs 205 may each include an integrated memory controller that may be implemented directly within the circuitry of each CPU 205. In some embodiments, a memory controller may be a separate integrated circuit that is located on the same die as the CPU 205. Each memory controller may be configured to manage the transfer of data to and from a system memory 210 of the IHS, in some cases using a high-speed memory bus 205a. The system memory 210 is coupled to CPUs 205 via one or more memory buses 205a that provide the CPUs 205 with high-speed memory used in the execution of computer program instructions by the CPUs 205. Accordingly, system memory 210 may include memory components, such as static RAM (SRAM), dynamic RAM (DRAM), NAND Flash memory, suitable for supporting high-speed memory operations by the CPUs 205. In certain embodiments, system memory 210 may combine persistent non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to diverse types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each CPU 205. All or portions of the chipset may be implemented directly within the integrated circuitry of an individual CPU 205. The chipset may provide the CPU 205 with access to a variety of resources accessible via one or more in-band buses. IHS 200 may also include one or more I/O ports 215 that may be used to couple the IHS 200 directly to other IHSs, storage resources, diagnostic tools, and/or other peripheral components. A variety of additional components may be coupled to CPUs 205 via a variety of in-line buses. For instance, CPUs 205 may also be coupled to a power management unit 220 that may interface with a power system of the chassis 100 in which IHS 200 may be installed. In addition, CPUs 205 may collect information from one or more sensors 225 via a management bus.

In certain embodiments, IHS 200 may operate using a BIOS (Basic Input/Output System) that may be stored in a non-volatile memory accessible by the CPUs 205. The BIOS may provide an abstraction layer by which the operating system of the IHS 200 interfaces with hardware components of the IHS. Upon powering or restarting IHS 200, CPUs 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for execution by CPUs 205. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 230.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As illustrated, CPUs 205 may be coupled to a network controller 240, such as provided by a Network Interface Controller (NIC) card that provides IHS 200 with communications via one or more external networks, such as the Internet, a LAN, or a WAN. In some embodiments, network controller 240 may be a replaceable expansion card or adapter that is coupled to a connector (e.g., PCIe connector of a motherboard, backplane, midplane, etc.) of IHS 200. In some embodiments, network controller 240 may support high-bandwidth network operations by the IHS 200 through a PCIe interface that is supported by the chipset of CPUs 205. Network controller 240 may operate according to firmware instructions that may be occasionally updated.

As indicated in FIG. 2, in some embodiments, CPUs 205 may be coupled to a PCIe card 255 that includes two PCIe switches 265a-b that operate as I/O controllers for PCIe communications, such as TLPs (Transaction Layer Packets), that are transmitted between the CPUs 205 and PCIe devices and systems coupled to IHS 200. Whereas the illustrated embodiment of FIG. 2 includes two CPUs 205 and two PCIe switches 265a-b, different embodiments may operate using different numbers of CPUs and PCIe switches. In addition to serving as I/O controllers that route PCIe traffic, PCIe switches 265a-b include switching logic that can be used to expand the number of PCIe connections that are supported by CPUs 205. PCIe switches 265a-b may multiply the number of PCIe lanes available to CPUs 205, thus allowing more PCIe devices to be connected to CPUs 205, and for the available PCIe bandwidth to be allocated with greater granularity. Each of the PCIe switches 265a-b may operate according to firmware instructions that may be occasionally updated.

Using the available PCIe lanes, the PCIe switches 265a-b may be used to implement a PCIe switch fabric. Also through this switch fabric, PCIe NVMe (Non-Volatile Memory Express) transmission may be supported and utilized in high-speed communications with SSDs, such as storage drives 235a-b, of the IHS 200. Also through this switch fabric, PCIe VDM (Vendor Defined Messaging) may be supported and utilized in managing PCIe-compliant hardware components of the IHS 200, such as in updating the firmware utilized by the hardware components.

As indicated in FIG. 2, IHS 200 may support storage drives 235a-b in various topologies, in the same manner as described with regard to the chassis 100 of FIG. 1. In the illustrated embodiment, storage drives 235a are accessed via a hardware accelerator 250, while storage drives 235b are accessed directly via PCIe switch 265b. In some embodiments, the storage drives 235a-b of IHS 200 may include a combination of both SSD and magnetic disk storage drives. In other embodiments, all of the storage drives 235a-b of IHS 200 may be identical, or nearly identical. In all embodiments, storage drives 235a-b operate according to firmware instructions that may be occasionally updated.

As illustrated, PCIe switch 265a is coupled via a PCIe link to a hardware accelerator 250, such as a DPU, SmartNlC, GPU and/or FPGA, that may be a connected to the IHS via a removable card or baseboard that couples to a PCIe connector of the IHS 200. In some embodiments, hardware accelerator 250 includes a programmable processor that can be configured for offloading functions from CPUs 205. In some embodiments, hardware accelerator 250 may include a plurality of programmable processing cores and/or hardware accelerators, which may be used to implement functions used to support devices coupled to the IHS 200. In some embodiments, the processing cores of hardware accelerator 250 include ARM (advanced RISC (reduced instruction set computing) machine) processing cores. In other embodiments, the cores of the DPUs may include MIPS (microprocessor without interlocked pipeline stages) cores, RISC-V cores, or CISC (complex instruction set computing) (i.e., x86) cores. Hardware accelerator may operate according to firmware instructions that may be occasionally updated.

In the illustrated embodiment, the programmable capabilities of hardware accelerator 250 implement functions used to support storage drives 235a, such as SSDs. In such storage drive topologies, hardware accelerator 250 may implement processing of PCIe NVMe communications with SSDs 235a, thus supporting high-bandwidth connections with these SSDs. Hardware accelerator 250 may also include one more memory devices used to store program instructions executed by the processing cores and/or used to support the operation of SSDs 235a such as in implementing cache memories and buffers utilized in support of high-speed operation of these storage drives, and in some cases may be used to provide high-availability and high-throughput implementations of the read, write and other I/O operations that are supported by these storage drives 235a. In other embodiments, hardware accelerator 250 may implement operations in support of other types of devices and may similarly support high-bandwidth PCIe connections with these devices. For instance, in various embodiments, hardware accelerator 250 may support high-bandwidth connections, such as PCIe connections, with networking devices in implementing functions of a network switch, compression and codec functions, virtualization operations or cryptographic functions.

As illustrated in FIG. 2, PCIe switches 265a-b may also support PCIe couplings with one or more GPUs (Graphics Processing Units) 260. Embodiments may include one or more GPU cards, where each GPU card is coupled to one or more of the PCIe switches 265a-b, and where each GPU card may include one or more GPUs 260. In some embodiments, PCIe switches 265a-b may transfer instructions and data for generating video images by the GPUs 260 to and from CPUs 205. Accordingly, GPUs 260 may include one or more hardware-accelerated processing cores that are optimized for performing streaming calculation of vector data, matrix data and/or other graphics data, thus supporting the rendering of graphics for display on devices coupled either directly or indirectly to IHS 200. In some instances, GPUs may be utilized as programmable computing resources for offloading other functions from CPUs 205, in the same manner as hardware accelerator 250. GPUs 260 may operate according to firmware instructions that may be occasionally updated.

As illustrated in FIG. 2, PCIe switches 265a-b may support PCIe connections in addition to those utilized by GPUs 260 and hardware accelerator 250, where these connections may include PCIe links of one or more lanes. For instance, PCIe connectors 245 supported by a printed circuit board of IHS 200 may allow various other systems and devices to be coupled to IHS. Through couplings to PCIe connectors 245, a variety of data storage devices, graphics processors and network interface cards may be coupled to IHS 200, thus supporting a wide variety of topologies of devices that may be coupled to the IHS 200.

As described, IHS 200 includes a remote access controller 230 that supports remote management of IHS 200 and of various internal components of IHS 200. In certain embodiments, remote access controller 230 may operate from a different power plane from the CPUs 205 and other components of IHS 200, thus allowing the remote access controller 230 to operate, and manage tasks to proceed, while the processing cores of IHS 200 are powered off. Various functions provided by the BIOS, including launching the operating system of the IHS 200, and/or functions of a TPM may be implemented or supplemented by the remote access controller 230. In some embodiments, the remote access controller 230 may perform various functions to verify the integrity of the IHS 200 and its hardware components prior to initialization of the operating system of IHS 200 (i.e., in a bare-metal state). In some embodiments, certain operations of the remote access controller 230, such as the operations described herein for updating firmware used by managed hardware components of IHS 200, may operate using validated instructions, and thus within the root of trust of IHS 200.

In some embodiments, remote access controller 230 may include a service processor 230a, or specialized microcontroller, which operates management software that supports remote monitoring and administration of IHS 200. The management operations supported by remote access controller 230 may be remotely initiated, updated, and monitored via a remote management interface 101, such as described with regard to FIG. 1. Remote access controller 230 may be installed on the motherboard of IHS 200 or may be coupled to IHS 200 via an expansion slot or other connector provided by the motherboard. In some instances, the management functions of the remote access controller 230 may utilize information collected by various managed sensors 225 located within the IHS. For instance, temperature data collected by sensors 225 may be utilized by the remote access controller 230 in support of closed-loop airflow cooling of the IHS 200. As indicated, remote access controller 230 may include a secured memory 230e for exclusive use by the remote access controller in support of management operations.

In some embodiments, remote access controller 230 may implement monitoring and management operations using MCTP (Management Component Transport Protocol) messages that may be communicated to managed devices 205, 235a-b, 240, 250, 255, 260 via management connections supported by a sideband bus 253. In some embodiments, the remote access controller 230 may additionally or alternatively use MCTP messaging to transmit Vendor Defined Messages (VDMs) via the in-line PCIe switch fabric supported by PCIe switches 265a-b. In some instances, the sideband management connections supported by remote access controller 230 may include PLDM (Platform Level Data Model) management communications with the managed devices 205, 235a-b, 240, 250, 255, 260 of IHS 200.

As illustrated, remote access controller 230 may include a network adapter 230c that provides the remote access controller with network access that is separate from the network controller 240 utilized by other hardware components of the IHS 200. Through secure connections supported by network adapter 230c, remote access controller 230 communicates management information with remote management interface 101. In support of remote monitoring functions, network adapter 230c may support connections between remote access controller 230 and external management tools using wired and/or wireless network connections that operate using a variety of network technologies. As a non-limiting example of a remote access controller, the integrated Dell Remote Access Controller (iDRAC) from Dell® is embedded within Dell servers and provides functionality that helps information technology (IT) administrators deploy, update, monitor, and maintain servers remotely.

Remote access controller 230 supports monitoring and administration of the managed devices of an IHS via a sideband bus 253. For instance, messages utilized in device and/or system management may be transmitted using I2C side-band bus 253 connections that may be individually established with each of the respective managed devices 205, 235a-b, 240, 250, 255, 260 of the IHS 200 through the operation of an I2C multiplexer 230d of the remote access controller. As illustrated in FIG. 2, the managed devices 205, 235a-b, 240, 250, 255, 260 of IHS 200 are coupled to the CPUs 205, either directly or directly, via in-line buses that are separate from the I2C side-band bus 253 connections used by the remote access controller 230 for device management.

In certain embodiments, the service processor 230a of remote access controller 230 may rely on an I2C co-processor 230b to implement sideband I2C communications between the remote access controller 230 and the managed hardware components 205, 235a-b, 240, 250, 255, 260 of the IHS 200. The I2C co-processor 230b may be a specialized co-processor or micro-controller that is configured to implement a I2C bus interface used to support communications with managed hardware components 205, 235a-b, 240, 250, 255, 260 of IHS. In some embodiments, the I2C co-processor 230b may be an integrated circuit on the same die as the service processor 230a, such as a peripheral system-on-chip feature that may be provided by the service processor 230a. The I2C sideband bus 253 is illustrated as single line in FIG. 2. However, sideband bus 253 may be comprised of multiple signaling pathways, where each may be comprised of a clock line and data line that couple the remote access controller 230 to I2C endpoints 205, 235a-b, 240, 250, 255, 260.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

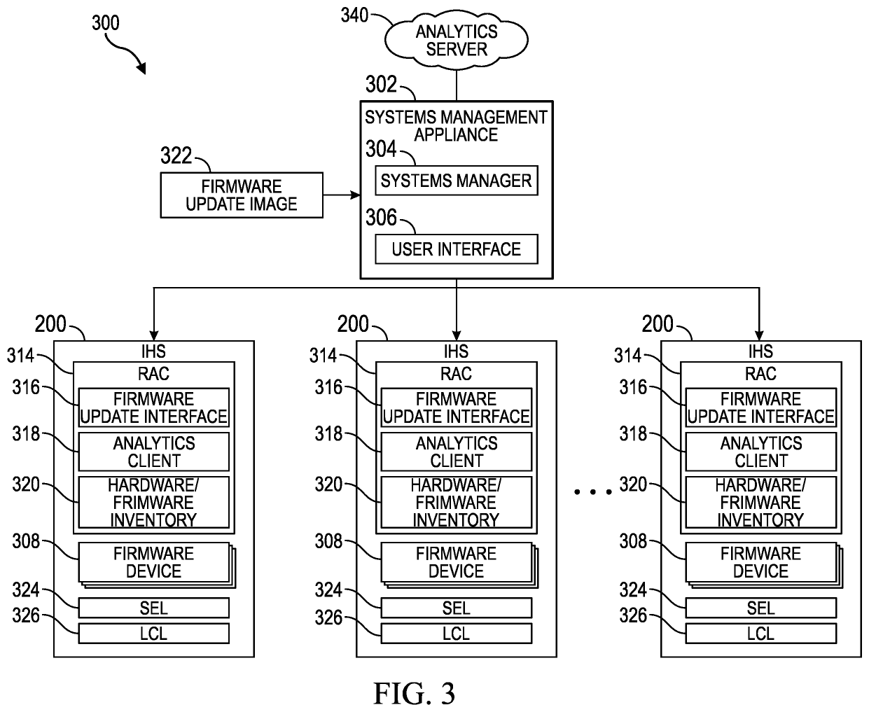

FIG. 3 is a diagram view illustrating several components of an example selective rebootless firmware update system 300 according to one embodiment of the present disclosure. The selective rebootless firmware update system 300 includes a systems management appliance 302 that manages multiple IHSs 200, such as to manage firmware updates that may be deployed on one or more firmware devices 308 from time to time. For example, the IHS 200 may include servers configured in a datacenter, computing cluster, or other group of IHSs 200. Each IHS 200 is configured with a RAC 314 that includes a firmware update interface 316, an analytics client 318, and a hardware/firmware inventory 320. The HW/FW repository 320 generally includes inventory information of some, most, or all firmware devices 308 implemented in the IHS 200. The inventory information may include, for example, the make and model of each firmware device 308 as well as a current version of firmware deployed on that firmware device 308.

The firmware devices 308 may be any IHS configurable device that may be updated with new firmware updates at an ongoing basis. For example, the firmware device 308 may include a non-volatile storage unit (e.g., hard disks, Solid State Drives (SSDs), etc.), Network Interface Cards (NICs), Graphical Processing Units (GPUs), RACs, Hardware RAID (HWRAID) devices, and the like. Citing a particular example, the firmware device 308 may include a storage drive 235b, those that are configured on a storage sled 115a-n, and/or storage resources 155 configured in a JBOD, such as described herein above with reference to FIGS. 1 and 2.

The systems management appliance 302 is installed with a systems manager 304 and a user interface 306. In one embodiment, the user interface 306 provides at least a portion of the features of the remote management interface 101 described herein above with reference to FIG. 2. The systems manager 304 monitors and controls the operation of various IHSs 200 described above with reference to FIG. 2. In one embodiment, systems manager 304 includes at least a portion of the Dell EMC OpenManage Enterprise (OME) that is installed on a secure virtual machine (VM), such as a VMWARE Workstation.

In general, when a particular firmware device 308 is updated with new firmware, the firmware update interface 316 communicates with the analytics client 318 to gather information associated with a behavior of the firmware device 308 being updated as well as other firmware devices 308 and the IHS 200 to generate a score indicating how well the IHS 200 performs after the firmware update was activated. The score may be saved by the firmware update interface 316 or other suitable component in the system 300 so that the next time the firmware update is applied to another firmware device 308 of the same type, the score may be used to help determine whether the firmware update should be applied to the firmware device 308.

In one embodiment, analytics client 318 may be incorporated to generate the score according to inputs (e.g., measurements) obtained from the firmware device 308 that was updated, other firmware devices 308 in the IHS 200 as well as the IHS 200 itself. The analytics client 318 may obtain information from the hardware/firmware inventory 320 to identify other firmware devices 308 in the system and using that information, correlate the performance of those other firmware devices 308 with data obtained from a System Event Log (SEL) 324 and/or a lifecycle Control Log (LCL) 326 maintained by the IHS 200. For example, the analytics client 318 may scan the SEL to determine that, following activation of the firmware update image 322 on a firmware device 308, a particular firmware device 308 begins to experience certain problems with interoperability of the firmware device 308 that has recently been updated with the new firmware update image 322. The analytics client 318 may use the association of the entries in the SEL and/or LCL with data obtained from the hardware/firmware inventory 320 to identify specific firmware devices 308 and their associated versions of firmware that may be experiencing problems after the new firmware update image 322 is activated on the target firmware device 308.

The analytics client 318 may be or include any suitable type of Machine Learning (ML) or Artificial Intelligence (AI) process. For example, the analytics client 318 may include features, or form a part of, the DELL PRECISION OPTIMIZER. In general, the analytics client 318 performs a machine learning process to derive certain performance features associated with the operation of the target firmware device 308 and other firmware devices 308 in the IHS 200. In one embodiment, the analytics client 318 monitors characteristics (e.g., telemetry data, log messages, etc.) of the target firmware device 308, other firmware devices 308, and/or IHS 200 to characterize behavior that may have occurred after the new firmware update image 322 was activated. Once the analytics client 318 has collected a sufficient amount of data over a period of time, it may then process the collected data using statistical descriptors to extract certain characteristics about problems exhibited by the target firmware device 308 to infer a relationship between the updated target firmware device 308 and any resulting problem experienced by the IHS 200. Data that is collected with regard to this behavior may be used by the analytics client 318 to extract those features associated with how the firmware update image 322 deployed on the target firmware device 308 causes the IHS 200 to operate, and generate a score based on those features. The analytics client 318 may use a machine learning algorithm such as, for example, a Bayesian algorithm, a Linear Regression algorithm, a Decision Tree algorithm, a Random Forest algorithm, a Neural Network algorithm, or the like.

The score generated by the analytics client 318, may therefore be proportional to how well the target firmware device 308, the other firmware devices 308, and the IHS 200 functions following activation of the update. The score may be based on any suitable scale value range. For example, the scale value range may extend from 0 to 100 in which 0 indicates the worst level of failure of the firmware update image 322, while 100 indicates the best level of a successful update with no problems experienced.

Once the score is generated, the system 300 may store the score such that it may be retrieved the next time that specific firmware update image 322 (e.g., type of firmware device 308, make and model of firmware device 308, and version of firmware update) is attempted to be deployed on another firmware device 308 of the same type. In one embodiment, the score, once generated, may be transmitted to an analytics server 340 that aggregates and stores scores for multiple firmware update scores across multiple IHSs 200. For example, the analytics server 340 may comprise at least a part of a vendor support portal maintained by a vendor of the IHSs 200. The vendor support portal may be, for example, a support website managed by the vendor that provides (e.g., manufactures and sells) the IHS 200 to the user of the IHS 200.

The analytics server 340 may aggregate and store scores generated by each of multiple IHSs 200 for each firmware device 308 (e.g., make, model, and hardware version) and the software version of the firmware update image 322. In one embodiment, the analytics server 340 may average the accumulated scores to arrive at a cumulative score. When the firmware update interface 316 receives a request to perform an update on a particular firmware device 308, it may access the score for that firmware update image 322 from the analytics server 340, and display it for view by the user, such as on the user interface 306. Given this information, the user may elect either to have the update performed on the target firmware device 308 or not.

In one embodiment, the analytics client 318 may identify certain other firmware devices 308 that may have been affected by the firmware update and store information about how well multiple versions of firmware on the other firmware devices 308 functioned with the target firmware update image 322, and store the information in the analytics server 340. Thus, when the firmware update interface 316 receives a request to perform an update using the firmware update image 322, it may access information about other firmware versions of other firmware devices 308 that may be recommended based upon the version of the target firmware update image 322, and present those recommendations to the user.

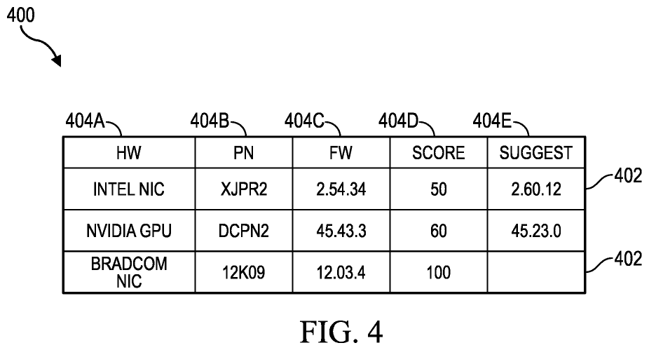

FIG. 4 illustrates an example recommendations window 400 that may be generated by the system 300 to provide the user with recommendations for performing a firmware update according to one embodiment of the present disclosure. The recommendations window 400 may be displayed, for example, on the user interface 306 in response to a user request to obtain the recommendations from the analytics server 340. For example, the user when considering the current update status of a particular IHS 200, may request that the analytics server 340 provide update recommendations for an IHS 200. In response to the request, the analytics server 340 may, using the firmware update interface 316, access the hardware/firmware inventory 320 to obtain information about the inventory of the IHS 200, and using that information, obtain scores for some, most, or all firmware devices 308 configured in the IHS 200, and display them for view by the user. Nevertheless, the system 300 may obtain and display the window 400 at any suitable time, such as in response to a request to perform a firmware update on a target firmware device 308 using a particular firmware update image 322.

The window 400 may be presented in table form with a number of rows 402 each indicating a particular firmware device 308, and a number of columns 404a-e for describing certain details of each firmware device 308. In particular, column 404a displays the name of the firmware device 308, column 404b displays the part number (PN) associated with the firmware device 308, column 404c displays the current firmware version deployed on its respective firmware device 308, 404d displays its score, while column 404e displays a recommended version for the firmware device 308.

As shown, an ‘Intel NIC’ firmware device 308, part number ‘XJPR2’ is shown with a current firmware version of ‘2.54.34’, and that the score for that version is 50. Because the score is relatively low, the analytics server 340 may suggest another version, namely version ‘2.60.12’, that may possess a relatively higher score. Additionally, a Nvidia GPU′ firmware device 308, part number ‘DCPN2’ is shown with a current firmware version of ‘45.43.3’, and that the score for that version is 60. Because the score is also relatively low, the analytics server 340 may suggest another version, namely version 45.23.0, that may possess a relatively higher score even though it appears to be an earlier version. The ‘Broadcom NIC’ firmware device 308, part number ‘12K09’, however, is shown with a current firmware version of ‘12.03.4’, and that the score for that version is 100. Because the score is relatively high (e.g., 100), the analytics server 340 recommends no update for the ‘Broadcom NIC’ firmware device 308.

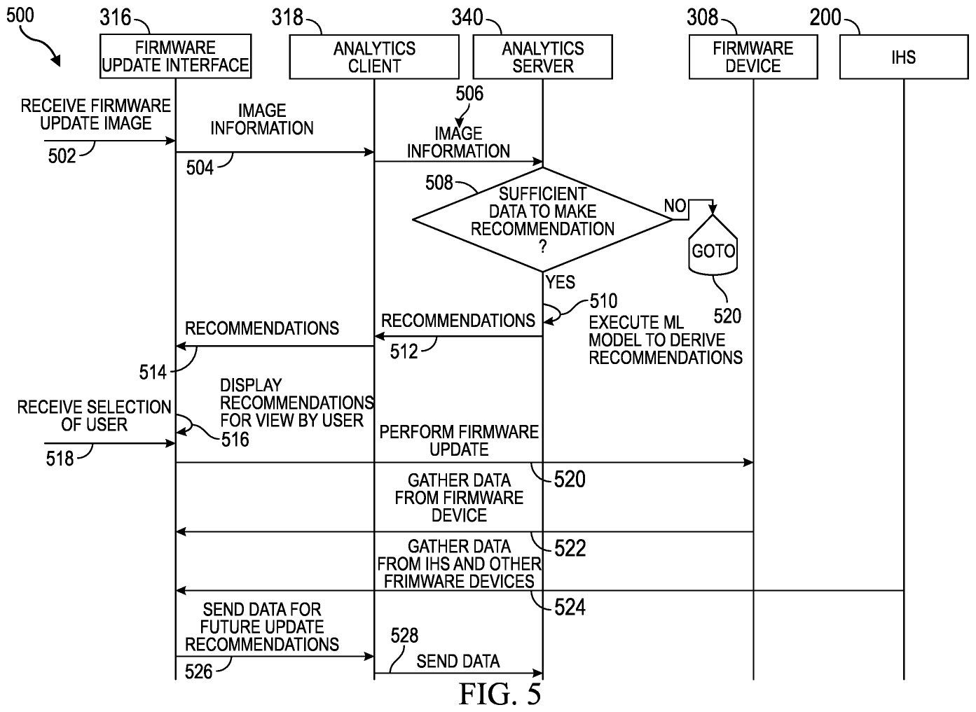

FIG. 5 is a flow diagram illustrating an example selective rebootless firmware update method 500 depicting how a firmware device 308 configured in an IHS 200 may be updated according to one embodiment of the present disclosure. In one embodiment, the selective rebootless firmware update method 500 may be performed in whole, or in part, by the firmware update interface 316, analytics client 318, analytics server 340, firmware device 308, and IHS 200 as described herein above. In other embodiments, the method 500 may be performed by any suitable combination of components that derive recommendations based on other firmware updates that have been performed in the past. Initially, a new software package or an updated version of an existing software package is promoted or made available by a provider of the software package and/or the firmware device 308 that the software package supports.

Initially at step 502, the firmware update interface 316 receives a firmware update image 322 associated with a firmware device 308 to be updated. The firmware update image 322 may be received, for example, from remote management controller 101 or from an online support portal managed by a vendor of the firmware device 308. Thereafter at step 504, the analytic client 318 receives information about the image from the firmware update interface 316 and forwards it to the analytics server 340 at step 506. The information may include, for example, the version of the firmware update image 322, and the type (e.g., make and model) of the firmware device 308 to be updated. In one embodiment, the information may include information about the IHS 200 as well as information about other firmware devices 308 configured in the IHS 200 that may have a bearing upon how the new firmware update image 322 may function on the firmware device 308.

At step 508, the analytics server 340 determines whether sufficient data exists to make a recommendation. For example, the analytics server 340 may decide that sufficient data exists when the quantity of previous updates (e.g., 50 previous updates) for which it has data meets a specified threshold. In one embodiment, the analytics server 340 may determine whether it has sufficient data by calculating a Gaussian distribution over certain data points stored for that particular firmware update image 322, and determining that sufficient data exists when the standard deviation of those data points meets a specified threshold. If sufficient data exists, processing continues at step 510; otherwise, processing continues at step 520 to continue with the firmware update as provided in step 502.

At step 510, the analytics server 340 executes a Machine Learning (ML) model to derive recommendations for the user. For example, the analytics server 340 may process data, such as problems identified from either or both of the SEL and/or LCL logs maintained by the IHS 200, issues encountered by the firmware device 308, erratic behavior experienced by the firmware device 308, IHS 200, and/or other firmware devices 308 following previous updates performed using that particular firmware update image 322. Once the analytics server 340 has generated recommendations, it sends them to the analytic client 318 at step 512, which in turn, forwards them to the firmware update interface 316 at step 514. The firmware update interface 316 displays the recommendations for view by the user at step 516. For example, the firmware update interface 316 may display the recommendations via a table, such as table 400 described herein above.

At step 518, the firmware update interface 316 receives user selection of a firmware update image 322 from the user. The selected firmware update image 322 may be the firmware update image 322 as received at step 502, or it may be a different firmware update image 322, such as one recommended via the recommendations. At step 520, the firmware update interface 316 performs a firmware update on the firmware device 308 using the user selected firmware update image 322. Following the firmware update, the firmware update interface 316 continues to gather data from the firmware device 308 at step 522 as well as the IHS 200 and other firmware devices 308 at step 524 over a period of time (e.g., 15 minutes, 30 minutes, 2 hours, etc.). The gathered data may be indicative of how well the firmware device 308, the IHS 200, and other firmware devices 308 perform as a result of the firmware update. Once gathered, the firmware update interface 316 may send the data to the analytic client 318 at step 526, which in turn, forwards it to the analytics server 340 at step 528 so that it may be used to derive recommendations for future firmware updates performed on other firmware devices 308 in the IHS 200 as well as other firmware devices 308 configured in other IHSs 200.

The aforedescribed method 500 may be performed each time a firmware update image 322 is to be updated on a firmware device 308 on the IHS 200 or another firmware device 308 configured in a different IHS 200. Nevertheless, when use of the selective rebootless firmware update method 500 is no longer needed or desired, the process ends.

Although FIG. 5 describes an example method 500 that may be performed to transfer firmware update images to a firmware device 308 in an IHS 200, the features of the disclosed processes may be embodied in other specific forms without deviating from the spirit and scope of the present disclosure. For example, certain steps of the disclosed method 500 may be performed sequentially, or alternatively, they may be performed concurrently. As another example, the method 500 may perform additional, fewer, or different operations than those operations as described in the present example. As yet another example, although the firmware update method 500 appears to show that a single firmware device 308 is updated, it should be appreciated that multiple firmware devices 308 may be configured to receive the firmware update image simultaneously, that is, at the same time.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a firmware device that is configured to be updated with firmware at an ongoing basis;
at least one processor; and
a memory coupled to the at least one processor, the memory having program instructions stored thereon that, upon execution by the processor, cause the IHS to:
receive a firmware update image associated with the firmware device;
after the firmware device is updated with the firmware update image, gather data associated with a behavior of the firmware device following the firmware update; and
generate a score for the firmware update based at least in part, on the behavior of the IHS following the firmware update.

2. The IHS of claim 1, wherein the instructions, upon execution, cause the IHS to:
when the firmware update image is attempted on another firmware device, display the score for view by a user; and
receive user input for selection of at least one of the firmware update image or a different firmware update image.

3. The IHS of claim 1, wherein the instructions, upon execution, cause the IHS to generate a warning when the score is less than a specified threshold.

4. The IHS of claim 1, wherein the instructions, upon execution, cause the IHS to suggest another version of the firmware update image based at least in part, on the score.

5. The IHS of claim 1, wherein the instructions, upon execution, cause the IHS to generate the score using an online portal that executes a Machine Learning (ML) model to generate recommendations for the firmware update image.

6. The IHS of claim 5, wherein the instructions, upon execution, cause the IHS to display the recommendations on a table, the table comprising one or more recommendations for other firmware devices configured in the IHS.

7. The IHS of claim 5, wherein the instructions, upon execution, cause the IHS to:
gather additional data associated with a behavior of the IHS; and
generate the score using the additional data.

8. The IHS of claim 5, wherein the instructions, upon execution, cause the IHS to:
gather additional data associated with a behavior of a plurality of other firmware devices configured in one or more other IHSs; and
generate the score using the additional data.

9. The IHS of claim 1, wherein the instructions are performed by a Remote Access Controller (RAC) configured in the IHS.

10. A selective rebootless firmware update method comprising:
receiving a firmware update image associated with a firmware device;
after the firmware device is updated with the firmware update image, gathering data associated with a behavior of the firmware device following the firmware update; and
generating a score for the firmware update based at least in part, on the behavior of the IHS following the firmware update.

11. The selective rebootless firmware update method of claim 10, further comprising:
when the firmware update image is attempted on another firmware device, displaying the score for view by a user; and
receiving user input for selection of at least one of the firmware update image or a different firmware update image.

12. The selective rebootless firmware update method of claim 10, further comprising generating a warning when the score is less than a specified threshold.

13. The selective rebootless firmware update method of claim 10, further comprising suggesting another version of the firmware update image based at least in part, on the score.

14. The selective rebootless firmware update method of claim 10, further comprising generating the score using an online portal that executes a Machine Learning (ML) model to generate recommendations for the firmware update image.

15. The selective rebootless firmware update method of claim 14, further comprising displaying the recommendations on a table, the table comprising one or more recommendations for other firmware devices configured in the IHS.

16. The selective rebootless firmware update method of claim 14, further comprising:
gathering additional data associated with a behavior of the IHS; and
generating the score using the additional data.

17. The selective rebootless firmware update method of claim 14, further comprising:
gathering additional data associated with a behavior of a plurality of other firmware devices configured in one or more other IHSs; and
generating the score using the additional data.

18. A memory storage device having program instructions stored thereon that, upon execution by one or more processors of an Information Handling System (IHS), cause the IHS to:
receive a firmware update image associated with a firmware device;
after the firmware device is updated with the firmware update image, gather data associated with a behavior of the firmware device following the firmware update; and
generate a score for the firmware update based at least in part, on the behavior of the IHS following the firmware update.

19. The memory storage device of claim 18, wherein the instructions, upon execution, cause the IHS to:
when the firmware update image is attempted on another firmware device, display the score for view by a user; and
receive user input for selection of at least one of the firmware update image or a different firmware update image.

20. The memory storage device of claim 18, wherein the instructions, upon execution, cause the IHS to generate the score using an online portal that executes a Machine Learning (ML) model to generate recommendations for the firmware update image.
